(19) United States
(12) Patent Application Publication
(10) Pub. No.: US 2022/0025946 A1
(43) Pub. Date: Jan. 27, 2022

(54) CALIPER BRAKE

(71) Applicant: MANDO CORPORATION, Pyeongtaek (KR)

(72) Inventors: Doyeon KIM, Gwangju (KR); Sukbong HONG, Uiwang (KR)

(21) Appl. No.: 17/373,942

(22) Filed: Jul. 13, 2021

(51) Int. Cl. F16D 65/18; F16J 15/32

(52) U.S. Cl. CPC F16D 65/18; F16D 2121/04; F16J 15/32

(57) ABSTRACT

Disclosed is a caliper brake including a carrier on which a pair of pad plates are installed to advance and retreat, a caliper housing slidably installed on the carrier and provided with a cylinder, a piston installed in the cylinder and provided to advance and retreat toward the pad plates by braking hydraulic pressure, a seal groove formed to be annularly recessed into an inner surface of the cylinder, and a ring-shaped seal member in close contact with an outer surface of the piston and accommodated in the seal groove, wherein the seal groove includes a bottom surface with which an outer circumferential surface of the seal member is in close contact, a first surface facing a front surface of the seal member, a second surface facing a rear surface of the seal member, and a bent surface in contact with the bottom surface and the second surface and provided in an arc shape.

### CROSS-REFERENCE TO RELATED APPLICATION(S)

This application is based on and claims priority under 35 U.S.C. § 119 to Korean Patent Application No. 10-2020-0090465, filed on Jul. 21, 2020, in the Korean Intellectual Property Office, the disclosure of which is incorporated by reference herein in its entirety.

### BACKGROUND

### 1. Field

The disclosure relates to a caliper brake, and more particularly, to a caliper brake including a seal member for rolling-back a piston when braking is released.

### 2. Description of the Related Art

In general, a caliper brake includes a carrier on which a pair of pad plates are mounted to advance and retreat to press a disk rotating together with a wheel of a vehicle, a caliper housing provided with a cylinder slidably mounted on the carrier and in which a piston is installed to advance and retreat by a braking hydraulic pressure, and the like.

The caliper brake performs braking by pressing the piston through braking hydraulic pressure, and may further include an electrically operated actuator and perform parking braking as a spindle unit, which receives a rotational force from a motor of the actuator and converts a rotational motion into a linear motion, presses the piston. In this case, in order to reduce a drag phenomenon in which friction between the disk and the friction pads attached to the pair of pad plates continues to occur after braking, the caliper brake may retreat the piston using a seal member accommodated in a seal groove formed on the cylinder and a roll-back chamber in the seal groove.

The seal member is formed in a ring shape to be inserted into the annular seal groove formed on an inner surface of the cylinder of the caliper housing and disposed between the inner surface of the cylinder and an outer surface of the piston. The seal member performs a function of preventing leakage of a braking fluid by sealing between the inner surface of the cylinder and the outer surface of the piston and a function of returning the piston to its original position. The function of the seal member of returning the piston, which has advanced, by an elastic force of the seal member to its original position after the braking is finished is called a roll-back.

However, when the sealing function of the seal member and the seal groove of preventing leakage of the braking fluid is improved, the roll-back function of returning the piston to its original position is deteriorated to occur the drag, and conversely, when the roll-back function of the seal member and the seal groove is improved, the sealing function may be deteriorated to leak the braking fluid.

Korean Patent Publication No. 10-2015-0069695 has been disclosed as an example of a conventional caliper brake including a seal member.

### SUMMARY

It is an aspect of the disclosure to provide a caliper brake capable of completely implementing a roll-back function of a seal member when braking is released to prevent a drag phenomenon and improve fuel efficiency of a vehicle.

It is an aspect of the disclosure to provide a caliper brake capable of completely implementing a sealing function of a seal member even during high-pressure braking to prevent leakage of a braking fluid.

Additional aspects of the disclosure will be set forth in part in the description which follows and, in part, will be obvious from the description, or may be learned by practice of the disclosure.

In accordance with an aspect of the disclosure, a caliper brake includes a carrier on which a pair of pad plates are installed to advance and retreat, a caliper housing slidably installed on the carrier and provided with a cylinder, a piston installed in the cylinder and provided to advance and retreat toward the pad plates by braking hydraulic pressure, a seal groove formed to be annularly recessed into an inner surface of the cylinder, and a ring-shaped seal member in close contact with an outer surface of the piston and accommodated in the seal groove, wherein the seal groove includes a bottom surface with which an outer circumferential surface of the seal member is in close contact, a first surface facing a front surface of the seal member, a second surface facing a rear surface of the seal member, and a bent surface in contact with the bottom surface and the second surface and provided in an arc shape.

The bottom surface may be provided parallel to advancing and retreating directions of the piston.

The first surface may have a first inclined surface formed to be inclined toward the pad plate, and the second surface may have a second inclined surface formed to be inclined toward the opposite side of the pad plate.

A depth of the first inclined surface may be formed to be about 45% to 55% of a depth of the bottom surface.

A depth of the second inclined surface may be formed to be about 25% to 35% of the depth of the bottom surface.

The bent surface may have a radius of curvature of 0.7 to 2 mm.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a schematic cross-sectional view of a caliper brake according to an embodiment of the disclosure;

FIG. 2 is an enlarged cross-sectional view of part A in FIG. 1;

FIG. 3 is an enlarged cross-sectional view of a seal member and a seal groove of the caliper brake according to an embodiment of the disclosure;

FIG. 4 is an enlarged cross-sectional view of the seal groove of the caliper brake according to an embodiment of the disclosure;

FIG. 5 is a cross-sectional view illustrating an operation of the seal member when a piston of the caliper brake according to an embodiment of the disclosure advances; and

FIG. 6 is a cross-sectional view illustrating an operation of the seal member when the piston of the caliper brake according to an embodiment of the disclosure retreats.

### DETAILED DESCRIPTION

Hereinafter, embodiments of the disclosure will be described in detail with reference to the accompanying drawings. The embodiments described below are provided by way of example so that those skilled in the art will be able to fully understand the spirit of the disclosure. The disclosure is not limited to the embodiments described below, but may be embodied in other forms. In order to clearly explain the disclosure, parts not related to the description are omitted from the drawings, and the width, length, thickness, etc. of the components may be exaggerated for convenience.

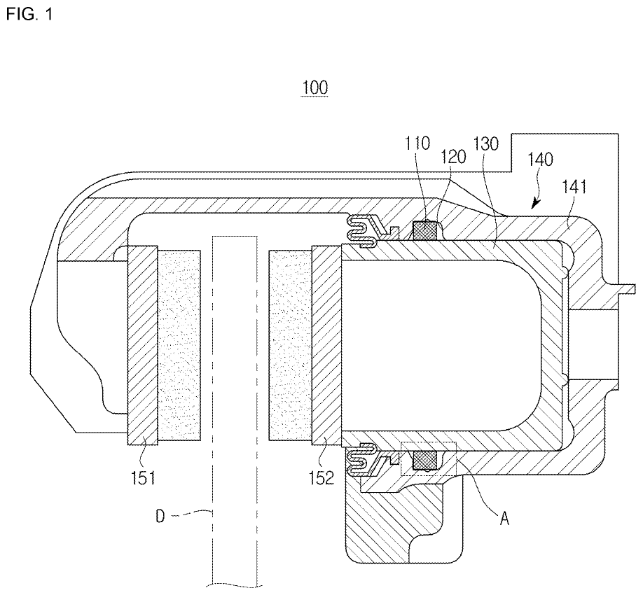

FIG. 1 is a schematic cross-sectional view of a caliper brake according to an embodiment of the disclosure.

Referring to FIG. 1, a caliper brake 100 according to an embodiment of the disclosure includes a disk D rotating with a wheel (not shown) of a vehicle, a carrier (not shown) on which a pair of pad plates 151 and 152 are installed to advance and retreat so as to press the disk D, a caliper housing 140 slidably installed on the carrier (not shown) and provided with a cylinder 141, a piston 130 installed in the cylinder 141 and provided to advance and retreat toward the pad plate 152 by braking hydraulic pressure, and a ring-shaped seal member 110 in close contact with an outer surface of the piston 130 and an inner surface of the cylinder 141.

As illustrated in FIG. 1, the caliper brake 100 according to an embodiment of the disclosure may be provided to implement only hydraulic braking, and although not shown in the drawing, may be provided to simultaneously implement hydraulic braking and electromechanical braking using a spindle-nut, and the like

In the following description, a direction in which the piston 130 advances toward the pad plate 152 (left in the drawing) is referred to as a forward direction, and a direction in which the piston 130 retreats from the pad plate 152 (right in the drawing) is referred to as a rearward direction.

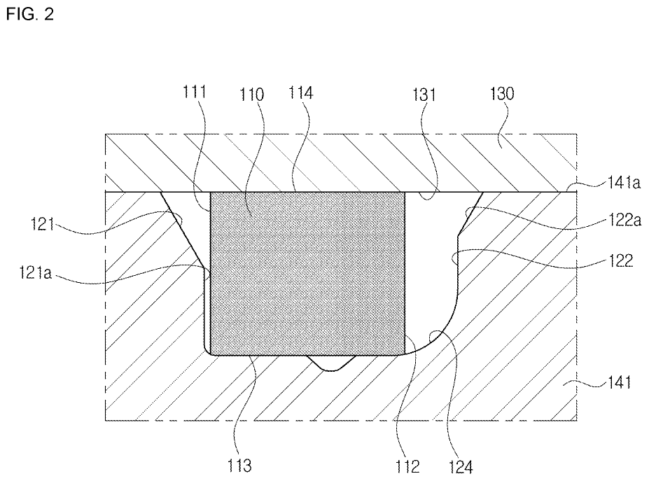

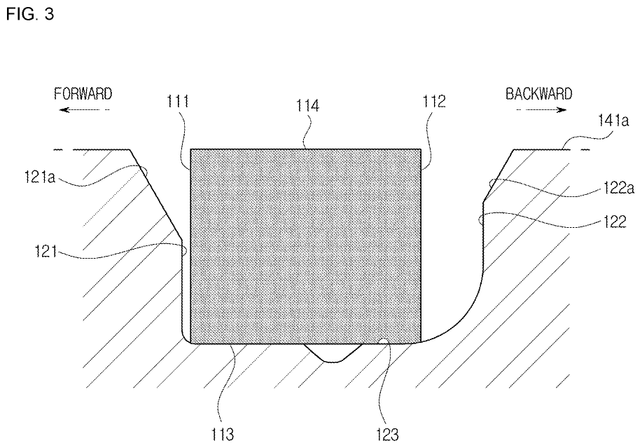

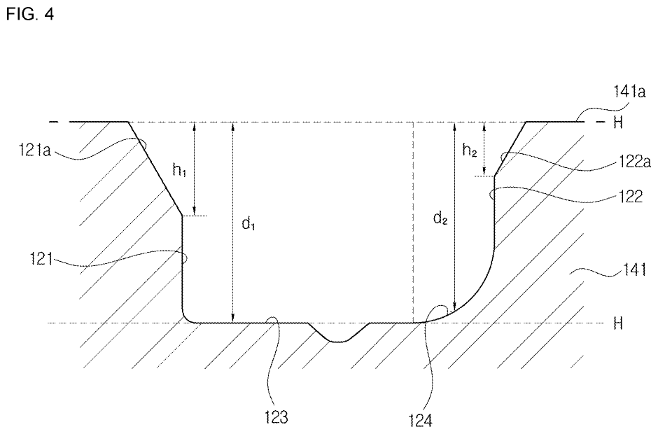

FIG. 2 is an enlarged cross-sectional view of part A in FIG. 1, FIG. 3 is an enlarged cross-sectional view of a seal member and a seal groove of the caliper brake according to an embodiment of the disclosure, and FIG. 4 is an enlarged cross-sectional view of the seal groove of the caliper brake according to an embodiment of the disclosure.

Referring to FIGS. 2 to 4, the seal member 110 formed in a ring shape may be accommodated in a seal groove 120 such that an inner circumferential surface 114 thereof is in contact with an outer circumferential surface 131 of the piston 130 and an outer circumferential surface 113 of the seal member 110 is in contact with an inner surface of the seal groove 120. A cross-section of the seal member 110 may be preferably provided in a rectangular shape.

A thickness of the seal member 110, that is, the thickness of the seal member 110 between the inner circumferential surface 114 and the outer circumferential surface 113 may be larger than a depth h1 of the seal groove 120. Accordingly, the seal member 110 may seal between the outer circumferential surface 131 of the piston 130 and a bottom surface 123 of the seal groove 120 and at the same time have an elastic restoring force.

The seal member 110 has a front surface 111 located in an advancing direction of the piston 130 and a rear surface 112 located in a retreating direction of the piston 130, and the front surface 111 and the rear surface 112 may be provided in parallel.

The seal groove 120 is formed to be recessed in an annular shape on the inner surface of the cylinder 141 provided in a hollow shape in the caliper housing 140, and accommodates the seal member 110.

Specifically, the seal groove 120 includes the bottom surface 123 on which the outer circumferential surface 113 of the seal member 110 is seated, a first surface 121 facing the front surface 111 of the seal member 110, and a second surface 122 facing the rear surface 112 of the seal member 110.

The bottom surface 123 seals between the seal member 110 and the cylinder 141 through friction with the outer circumferential 113 of the seal member 110.

The bottom surface 123 is formed parallel to a central axis or the advancing and retreating directions of the piston 130. Specifically, the bottom surface 123 is formed such that an angle of the surface on which the outer circumferential surface 113 of the seal member 110 is seated is parallel to the central axis of the piston 130 or an inner circumferential surface 141a of the cylinder 141. In other words, a depth d1 of the bottom surface 123 or a distance between the bottom surface 123 and the outer circumferential surface 131 of the piston 130 is formed to be constant.

Therefore, even in a case where the seal member 110 is elastically deformed forward when the piston 130 advances, because the depth d1 of the bottom surface 123 is constant, the sealing performance of the seal member 110 may be maintained compared to a case where the depth decreases toward the front. A detailed operation thereof will be described later.

Also, even in a case where the seal member 110 is elastically deformed rearward when the piston 130 retreats, because the depth d1 of the bottom surface 123 is constant, less resistance may be generated compared to a case where the depth decreases toward the rear, and a drag phenomenon may be reduced. A detailed operation thereof will be described later.

A front side of the bottom surface 123 is connected to the first surface 121, and a rear side of the bottom surface 123 is in contact with a bent surface 124 and connected to the second surface 122 through the bent surface 124.

The bent surface 124 is formed in an arc shape such that one side is in contact with the bottom surface 123 and the other side is in contact with the second surface 122. The bent surface 124 may have a radius of curvature of 0.7 to 2 mm, preferably 1 mm. Therefore, a depth d2 of the bent surface 124 is formed to be smaller toward the rear.

When braking hydraulic pressure is applied, a braking fluid is introduced from the rear of the seal member 110, and in this case, the sealing function of a rear portion of the seal member 110 is improved by the bent surface 124 provided at the rear of the bottom surface 123, thereby preventing leakage of the braking fluid.

In addition, as the above-described bent surface 124 is provided, an excessive roll-back phenomenon that occurs when the seal member 110 is elastically deformed backward may be prevented. Specifically, when the seal member 110 is rolled back, the seal member 110 may be elastically deformed rearward or may slip rearward so that the seal member 110 may move rearward. At this time, as the depth d2 of the bent surface 124 decreases toward the rear, the seal member 110 is elastically deformed while receiving a tightening force in the front and radial directions, and the elastic deformation force of the seal member 110 may prevent the seal member 110 from being excessively rolled back.

The first surface 121 may be formed to be bent in a direction from the bottom surface 123 toward the piston 130 to face the front surface 111 of the seal member 110. Preferably, the first surface 121 may be provided perpendicular to the bottom surface 123. In this case, an edge at which the first surface 121 and the bottom surface 123 are connected may be formed to be rounded, and a radius of curvature of the edge is provided to be smaller than the radius of curvature of the bent surface 124.

The first surface 121 may be in close contact with the front surface 111 due to elastic deformation of the seal member 110 when the piston 130 advances, thereby limiting the movement of the seal member 110.

The second surface 122 may be formed to be bent in a direction from the bottom surface 123 toward the piston 130 to face the rear surface 112 of the seal member 110.

In a case where the seal member 110 is excessively roped back by an elastic reaction force when the piston 130 retreats, the second surface 122 may be in close contact with the rear surface 112 to limit the movement of the seal member 110.

The first surface 121 may have a first inclined surface 121a formed to be inclined in the advancing direction of the piston 130, and the second surface 122 may have a second inclined surface 122a formed to be inclined in the retreating direction of the piston 130.

The first inclined surface 121a may be formed from the first surface 121 to the depth h1 of about 45% to 55% with respect to the depth d1 of the bottom surface 123. However, the shape of the first inclined surface 121a is not limited thereto and may be variously changed. That is, the depth and angle of the first inclined surface 121a may be changed depending on a required rollback amount, and should be understood in the same manner.

The second inclined surface 122a may be formed from the second surface 122 to a depth h2 of about 25% to 35% with respect to the depth d1 of the bottom surface 123. However, the shape of the second inclined surface 122a is not limited thereto and may be variously changed. That is, the depth and angle of the second inclined surface 122a may be changed depending on a required amount of braking fluid, etc., and should be understood in the same manner.

Accordingly, a volume of a space formed by the first inclined surface 121a may be larger than a volume of a space formed by the second inclined surface 122a.

The space formed by the first inclined surface 121a is a space formed between the first inclined surface 121a and the outer circumferential surface 131 of the piston 130, and may be filled with the seal member 110 by elastic deformation of the seal member 110 when the piston 130 advances. The space formed by the first inclined surface 121a may provide an additional space in which the seal member 110 may be elastically deformed forward even when the piston 130 is pressed forward, so that the occurrence of slip between the inner circumferential surface 114 of the seal member 110 and the outer circumferential surface 131 of the piston 130 may be reduced.

The space formed by the second inclined surface 122a is a space formed between the second inclined surface 122a and the outer circumferential surface 131 of the piston 130, and may be filled with the seal member 110 by elastic deformation of the seal member 110 when the piston 130 retreats. The space formed by the second inclined surface 122a may provide an additional space in which the seal member 110 may be elastically deformed rearward even when the piston 130 retreats, so that the occurrence of slip between the inner circumferential surface 114 of the seal member 110 and the outer circumferential surface 131 of the piston 130 may be prevented.

Hereinafter, an operation of the seal member 110 when the piston 130 of the caliper brake 100 according to an embodiment of the disclosure advances will be described.

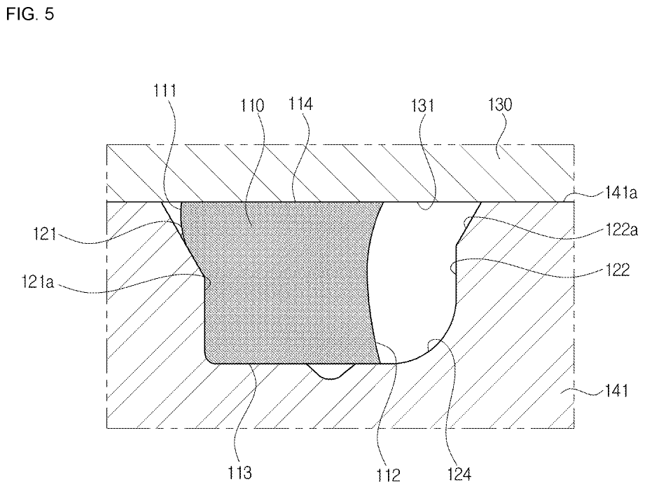

FIG. 5 is a cross-sectional view illustrating an operation of the seal member when a piston of the caliper brake according to an embodiment of the disclosure advances.

Referring to FIGS. 1 and 5, the piston 130 advances in a stationary state as the braking hydraulic pressure changes from a low pressure to a high pressure, and thus the seal member 110 is elastically deformed. However, the piston 130 may advance by the pressing operation of an actuator (not shown) such as a spindle-nut (not shown) as well as the braking hydraulic pressure, and it should be understood that the operation of the seal member 110 by the pressing and releasing operations of the actuator is the same as that by the operations of the braking hydraulic pressure.

During the braking operation, the seal member 110 is elastically deformed forward in a state in which the outer circumferential surface 113 and the inner circumferential surface 114 are in close contact with the bottom surface 123 of the seal groove 120 and the outer circumferential surface 131 of the piston 130, respectively.

As the braking hydraulic pressure increases, the front surface 111 of the seal member 110 is in close contact with the first surface 121 of the seal groove 120, and a portion of the seal member 110 is in close contact with the first inclined surface 121a to fill a front space of the seal member 110.

As the depth d1 of the bottom surface 123 is provided to be constant, a sealing state between the piston 130 and the seal member 110 may be maintained even when the seal member 110 is elastically deformed.

For example, in a case where the depth d1 of the bottom surface 123 is formed to decrease toward the front, when the seal member 110 is elastically deformed forward by the braking hydraulic pressure, a rear portion of the seal member 110 has a weaker tightening force than a front portion of the seal member 110. In this case, the braking fluid may leak between the inner circumferential surface 114 of the seal member 110 and the outer circumferential surface 131 of the piston 130 because a high-pressure braking hydraulic pressure is applied to the rear of the seal member 110.

However, in the caliper brake 100 according to an embodiment of the disclosure, as the depth d1 of the bottom surface 123 is provided to be constant, a tightening force acting on the seal member 100 in a radial direction does not change even when the seal member 100 is elastically deformed forward, so that the sealing state between the piston 130 and the seal member 110 may be maintained.

Hereinafter, an operation of the seal member 110 during a braking release operation of the caliper brake 100 according to an embodiment of the disclosure will be described.

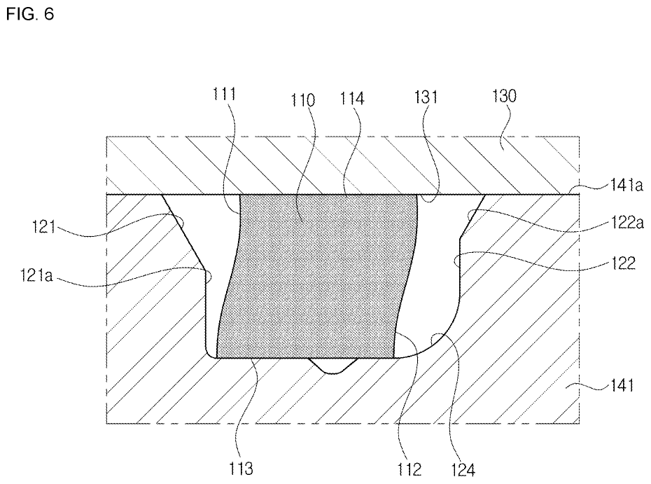

FIG. 6 is a cross-sectional view illustrating an operation of the seal member when the piston of the caliper brake according to an embodiment of the disclosure retreats.

Referring to FIGS. 1 and 6, when the braking hydraulic pressure is released in a state in which the piston 130 is pressed forward, the piston 130 retreats by elastic deformation forces of the seal member 110 and an elastic member (not shown), and thus the seal member 110 is elastically deformed. However, the operation of the piston 130 retreating is not limited thereto, and it should be understood that the retreat of the piston 130 by other methods is the same as the retreat of the piston 130 by the elastic deformation force.

When the piston 130 retreats, the seal member 110 is elastically deformed backward in a state in which the outer circumferential surface 113 and the inner circumferential surface 114 are in close contact with the bottom surface 123 of the seal groove 120 and the outer circumferential surface 131 of the piston 130, respectively.

As the braking hydraulic pressure is released, the rear surface 112 of the seal member 110 may be in close contact with the second surface 122 of the seal groove 120, and a portion of the seal member 110 may be in close contact with the second inclined surface 122a.

As the seal member 110 passes the bent surface 124 formed in an arc shape while being elastically deformed rearward, the elastic deformation force acting on the seal member 110 forward is increased. This elastic deformation force presses the seal member 110 forward to prevent excessive roll-back, and improves the sealing function of the seal member 110 to prevent leakage of the braking fluid.

In the caliper brake 100 according to an embodiment of the disclosure as described above, as the depth d1 of the bottom surface 123 is provided to be constant, the seal member 100 may be elastically deformed smoothly to reduce the drag phenomenon. In addition, in the caliper brake 100 according to an embodiment of the disclosure, as the bent surface 124 having the depth d2 that decreases toward the rear is provided, the tightening force applied to the rear portion of the seal member 110 may be increased, so that leakage of the braking fluid may be prevented and excessive roll-back may be prevented.

As is apparent from the above, a caliper brake according to an embodiment of the disclosure can completely implement a roll-back function of a seal member when braking is released to prevent a drag phenomenon and improve fuel efficiency of a vehicle.

Further the caliper brake according to an embodiment of the disclosure can completely implement a sealing function of the seal member even during high-pressure braking to prevent leakage of a braking fluid.

While the disclosure has been particularly described with reference to exemplary embodiments, it should be understood by those of skilled in the art that various changes in form and details may be made without departing from the spirit and scope of the disclosure.

What is claimed is:

1. A caliper brake comprising:
a carrier on which a pair of pad plates are installed to advance and retreat;
a caliper housing slidably installed on the carrier and provided with a cylinder;
a piston installed in the cylinder and provided to advance and retreat toward the pad plates by braking hydraulic pressure;
a seal groove formed to be annularly recessed into an inner surface of the cylinder; and
a ring-shaped seal member in close contact with an outer surface of the piston and accommodated in the seal groove,
wherein the seal groove comprises:
a bottom surface with which an outer circumferential surface of the seal member is in close contact; a first surface facing a front surface of the seal member; a second surface facing a rear surface of the seal member; and a bent surface in contact with the bottom surface and the second surface and provided in an arc shape.

2. The caliper brake according to claim 1, wherein
the bottom surface is provided parallel to advancing and retreating directions of the piston.

3. The caliper brake according to claim 2, wherein
The first surface has a first inclined surface formed to be inclined toward the pad plate, and
the second surface has a second inclined surface formed to be inclined toward the opposite side of the pad plate.

4. The caliper brake according to claim 3, wherein
a depth of the first inclined surface is formed to be about 45% to 55% of a depth of the bottom surface.

5. The caliper brake according to claim 4, wherein
a depth of the second inclined surface is formed to be about 25% to 35% of the depth of the bottom surface.

6. The caliper brake according to claim 1, wherein
the bent surface has a radius of curvature of 0.7 to 2 mm.
